(19) United States
(12) Patent Application Publication
(10) Pub. No.: US 2019/0286795 A1
(43) Pub. Date: Sep. 19, 2019

(54) Securely and Dynamically Identifying Transaction Authorizers

(71) Applicant: CA, Inc., New York, NY (US)

(72) Inventor: Bhuvan Bhatt, Hyderabad (IN)

(21) Appl. No.: 15/919,930

(22) Filed: Mar. 13, 2018

(51) Int. Cl. G06F 21/30; H04L 29/06

(52) U.S. Cl. CPC G06F 21/30; G06F 2221/2115; H04L 63/0421

(57) ABSTRACT

Techniques are disclosed relating to secure processing of requests from users to access resources. In some embodiments, an apparatus receives, in a first transaction, a request from a first user to access a first resource. In some embodiments, the apparatus is configured to process the request to determine a set of authorizers, with encrypted identifiers, to authorize the transaction. In some embodiments, the apparatus is configured to pseudo-randomly select an authorizer for the request from among the determined set of authorizers with encrypted identifiers. In some embodiments, the apparatus is configured to send a request for approval to the selected authorizer. In some embodiments, the apparatus is configured to transmit a response to the first user based on a decision from the authorizer concerning the first transaction. In some embodiments, the secure authorizer selection module communicates the decision to the user without identifying the authorizer.

### BACKGROUND

### Technical Field

This disclosure relates generally to the security of access-controlled resources, and in particular, to pseudo-randomly selecting authorizers for requests and cryptographically securing authorizer identity.

### Description of the Related Art

Access to certain types of access-controlled resources may require authorization from one or more individuals or entities. Users may attempt to circumvent such security measures by working with authorizers to have their requests improperly authorized. This may be particularly problematic if the identity of authorizers is known to requesting users.

### SUMMARY

Techniques are disclosed relating to the security of transactions to access resources that involve requests and authorization. In some embodiments, a secure authorizer selection module determines a set of potential authorizers whose identities are cryptographically protected. In some embodiments, the secure authorizer selection module processes a request from a user and accesses a database to determine a set of potential authorizers. In some embodiments, the secure authorizer selection module pseudo-randomly selects an authorizer from the determined set of potential authorizers. Once an authorizer has been selected by the secure authorizer selection module, in some embodiments, the request to access a resource is sent to the authorizer for approval or rejection. Once the authorizer has rejected or approved the request, in some embodiments, a notification is sent to the secure authorizer selection module of the decision. In some embodiments, the secure authorizer selection module sends a notification of the decision to the user without identifying the authorizer.

### BRIEF DESCRIPTION OF THE DRAWINGS

FIG. 1 is a block diagram illustrating an exemplary secure authorizer selection module, according to some embodiments.

FIG. 2 is a flow diagram illustrating processing a request that requires a single approver, according to some embodiments.

FIG. 3 is a flow diagram illustrating processing a request that requires multiple approvers, according to some embodiments.

FIG. 4, is a diagram illustrating an exemplary transaction, according to some embodiments.

FIG. 5 is a diagram illustrating an exemplary transaction involving transaction timing and attempt thresholds, according to some embodiments.

FIG. 6 is a table illustrating an exemplary database, according to some embodiments.

FIG. 7 is a flow diagram illustrating an exemplary method for securely processing a user request, according to some embodiments.

FIG. 8 is a block diagram illustrating an exemplary computing device, according to some embodiments.

This specification includes references to various embodiments, to indicate that the present disclosure is not intended to refer to one particular implementation, but rather a range of embodiments that fall within the spirit of the present disclosure, including the appended claims. Particular features, structures, or characteristics may be combined in any suitable manner consistent with this disclosure.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “resource negotiator module configured to generated a predicted queue map” is intended to cover, for example, a module that performs this function during operation, even if the corresponding device is not currently being used (e.g., when its battery is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed mobile computing device, for example, would not be considered to be “configured to” perform some specific function, although it may be “configurable to” perform that function. After appropriate programming, the mobile computing device may then be configured to perform that function.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

### DETAILED DESCRIPTION

### Overview of a Secure Authorizer Selection Module

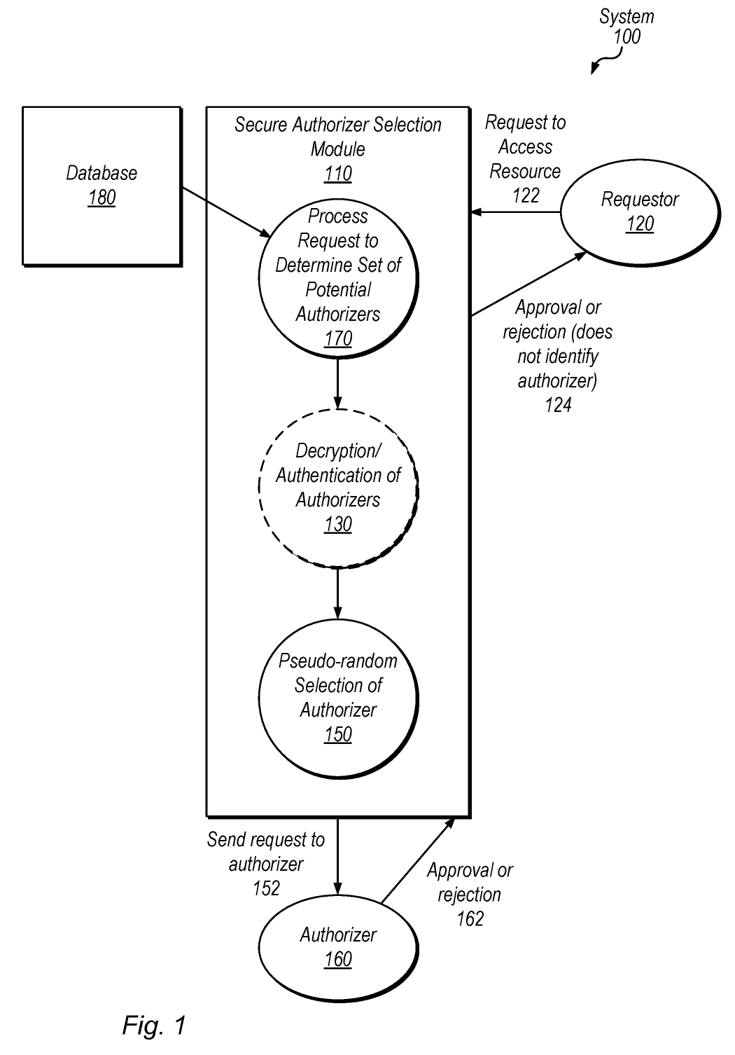

FIG. 1 is a block diagram illustrating an exemplary system that includes a secure authorizer selection module, according to some embodiments. In the illustrated embodiment, system 100 includes secure authorizer selection module 110 and database 180. In the illustrated embodiment, module 110 is configured to communicate with a requestor 120 and an authorizer 160. In the illustrated embodiment, module 110 performs operations 170, 130, and 150 to securely select an authorizer for a transaction initiated by requestor 120.

In the illustrated embodiment, module 110 receives a request 122, from requestor 120 to access a resource. In some embodiments, system 100 controls access to the resource. Non-limiting examples of resources to which access may be requested include: secure data files, access to one or more networks, policy control information, access to a physical location or structure, access to one or more computing devices, information that tracks one or more activities, information that tracks one or more users, cryptographic certificates, sensitive administrative communications/decisions, passwords, etc.

At 170, in the illustrated embodiment, module 110 processes the request 122 and accesses database 180 to determine a set of potential authorizers. Module 110 may process and categorize the request based on one or more of the following parameters: restrictions or permissions for requestor 120, properties of the requested resource, type of computing device initiating the request, type of account used by requestor 120 in making the request, one or more workflow procedures associated with the request, attempt thresholds, time thresholds, number of authorizers needed for the request, etc. In some embodiments, processing the request includes determining a set of potential authorizers from database 180 based on the determined parameters. For example, module 110 may query database 180 to determine authorizers that match the parameters. Thus, various different requests may have different sets of potential authorizers. In various embodiments, parameters for the request may be specified by the request and/or may be determined by module 110 independently of the request.

In some embodiments, information identifying the determined authorizers may be encrypted. In the illustrated embodiment, module 110 optionally decrypts and/or authenticates the identifiers of the determined authorizers at 130. Decryption may use a cryptographic key that is secured by module 110 to determine authorizer identify. Authenticating determined authorizers may involve certificate verification e.g. private/public certificate techniques, verifying a password, verifying a token (e.g. as provided by a wireless card, smartcard, etc.), and/or verifying biometric characteristics (e.g. fingerprint, voiceprint, iris scan data, etc.). In other embodiments, module 110 may use encrypted identifiers without decrypting them (e.g., it may send encrypted information to another device or module that actually determines how to contact one or more selected authorizers).

At 150, in the illustrated embodiment, module 110 pseudo-randomly selects one or more authorizers from the set of potential authorizers. In the illustrated embodiment, the module 110 sends a request 152 to the pseudo-randomly selected authorizer 160. In the illustrated embodiment, authorizer 160 approves or rejects the request. In the illustrated embodiment, notification of the approval or rejection of the request is sent to module 110 at 162. In the illustrated embodiment, module 110 sends a notification of the approval or rejection to requestor 120 at 124. As shown, in some embodiments, module 110 sends the decision to requestor 120 without identifying the authorizer. In various embodiments, the pseudo-random selection and identity obfuscation techniques disclosed herein may improve system security.

Pseudo-random selection may be performed using any of various appropriate implementations, including one or more random number generators, which may be included in system 100. The term “pseudo-random” refers to values that satisfy one or more statistical tests for randomness but are typically produced using a definite mathematical process, e.g., based on one or more seed values, which may be stored or generated by system 100. In some embodiments, any of various sequences described herein as pseudo-random may actually be random, but true randomness is typically difficult to achieve using computer hardware. In some embodiments, among a set of N authorizers each having an index, a particular authorizer may be selected using a determined random number modulus N, for example.

In some embodiments, the secure authorizer selection module 110 (or another module) pseudo-randomly selects an authorizer without knowing the identity of the authorizer (e.g. the identifier of the authorizer is encrypted and module 110 does not decrypt the identifier), which may in turn prevent requestor 120 from determining the identity. In these embodiments, some other system may decrypt the identifier of the authorizer and send request 152 to the authorizer. In some embodiments, module 110 is configured to provide the identity of the authorizer to requestor 120, but only after a decision has been made for request 122. In other embodiments, module 110 is configured to encrypt the identifier of the requestor 120, to further secure the authorization of a transaction (e.g. authorizer does not know the identity of the user and cannot authorize the transaction based on a malicious scheme between the authorizer and the requestor). In these embodiments, module 110 may provide attributes of the requestor 120 to the authorizer, without providing the identity of the requestor.

In some embodiments, identification information for requestors is stored in a non-encrypted form but module 110 is configured to encrypt this identification information such that it is unavailable to requestor 120. This may allow the encrypted identification information to be sent with decision 124, for example, without compromising this information.

In some embodiments, the determined set of potential authorizers includes authorizers of equal or greater authority level than the authority level of the requestor. For example, in some embodiments, the determined set of potential authorizers includes a system administrator and a system manager. System 100 may maintain information for various entities having different levels in an authority hierarchy. In some embodiments, the set of potential authorizers may be based on the type of resource requested. For example, if a request is submitted for approval involving access to highly sensitive data, in some embodiments, entities at a relatively higher level in the authority hierarchy may be identified as potential authorizers than for requests for less sensitive data.

### Example of a Request Requiring a Single Authorizer

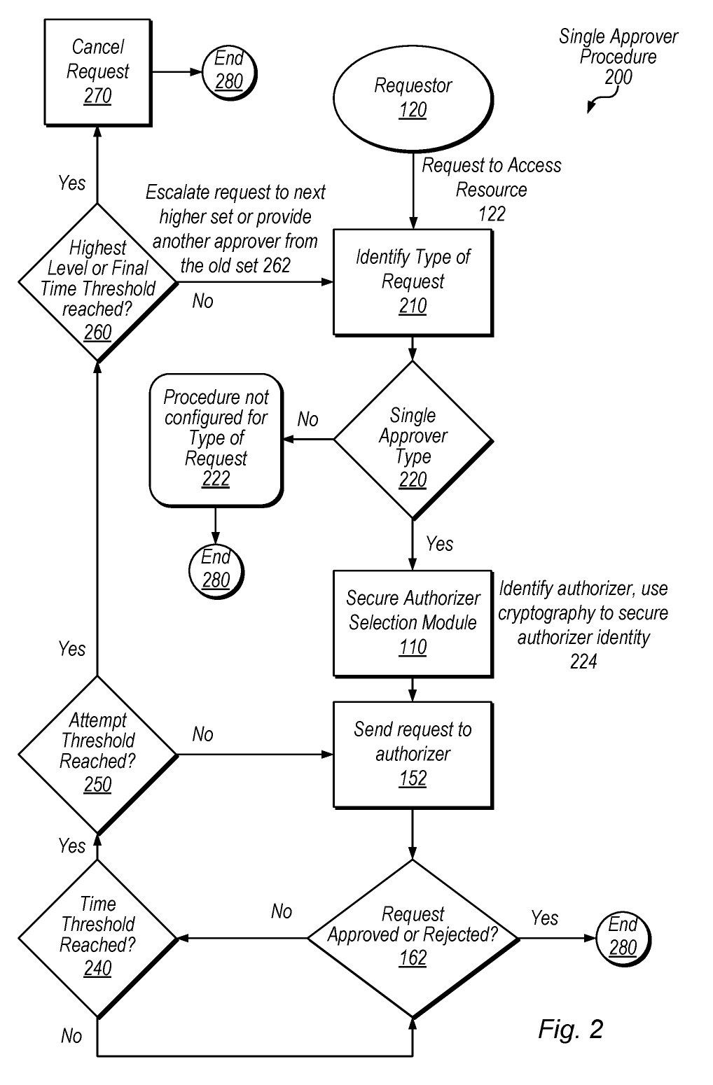

FIG. 2 is a flow diagram illustrating a procedure for a type of request requiring a single approver, according to some embodiments.

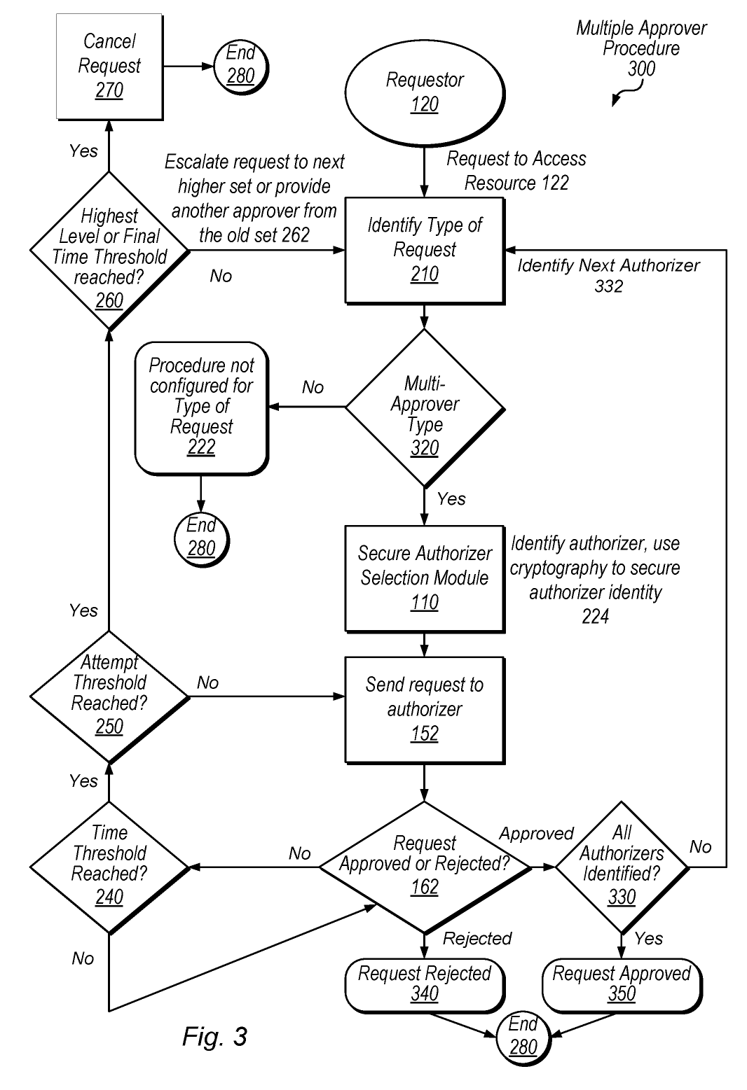

At 122, in the illustrated embodiment, a requestor 120 submits a request. At 210, in the illustrated embodiment, the type of request is identified. At decision block 220 system 100 determines whether the request is a single approver type. If not, flow proceeds to 222, in the illustrated embodiment and the flow ends at 280 (in this instance, a multi-approver procedure may be initiated to handle the request). If the procedure is configured for a single approver type of request, the request is sent to the secure authorizer selection module 110 (note that various functionality discussed with reference to FIGS. 2 and 3 may be performed by module 110 or some other element of system 100).

At 224, in the illustrated embodiment, module 110 identifies an authorizer (e.g., pseudo-randomly) and uses cryptography to secure the authorizer's identity. At 152, module 110 sends a request to the authorizer for approval or rejection. At decision block 162, in the illustrated embodiment, system 100 determines whether the request has been approved or rejected. If so, the flow ends at 280. If the request has not be approved or rejected, flow proceeds to 240, where system 100 determines whether a time threshold has been reached. If the time threshold has not been reached, flow returns to 162. If the time threshold has been reached, flow proceeds to 250.

At 250, in the illustrated embodiment, system 100 determines whether an attempt threshold has been reached. If the attempt threshold has not been reached, flow returns to 152, where system 100 resends a request to an authorizer (e.g. a second or subsequent attempt to send a request to the identified authorizer for rejection or approval). If the attempt threshold has been reached (e.g. system 100 has sent a request for approval a number of times that meets the threshold), flow proceeds to 260.

At 260, in the illustrated embodiment, system 100 determines whether the highest level of authority for potential authorizers has been reached or whether the final time threshold has been reached. If the highest level of authority or the final time threshold have not been reached, flow proceeds to 262. At 262, in the illustrated embodiment, system 100 provides another approver from an old set of potential authorizers or escalates the request to the next higher set of potential authorizers. At 260, in the illustrated embodiment, if the final time threshold or the highest level of authorizer has been reached, the request is cancelled 270 and the flow ends 280.

In some embodiments, a time threshold includes a determined amount of time (e.g. minutes) that is allowed pass before a request to access a resource should be authorized. In some embodiments, an attempt threshold includes a determined number of attempts to send a request for rejection or approval to an authorizer before the request is escalated to an authorizer selected from a higher set of potential authorizers. In some embodiments, a final time threshold includes a determined amount of time (e.g. hours or days) that is allowed pass before a request to access a resource is canceled 270. In various embodiments, the time threshold, attempt threshold, and final time threshold are determined by an administrator of procedure 200.

In some embodiments, the identifier of one or more authorizers is secured cryptographically using Private/Public key encryption or AES (Advanced Encryption Standard) Key, for example. Public/Private key encryption may be used to authenticate an authorizer (e.g. authorizer uses his or her public key to authenticate their identity) and/or to create a secure channel to encrypt information (e.g. an identifier of an authorizer). In some embodiments, one of the paired keys is public, while the other key is private. In some embodiments, one module secretly stores the private key and provides copies of the public key to one or more other modules or users. In some embodiments, the public key allows users to make requests that can only be decrypted by the module with the private key (which may then forward decrypted requests to other modules). In some embodiments, the private key may be used to cryptographically sign messages or data so that other modules with the public key can confirm the origin of the messages or data. Thus, in various embodiments, public/private key techniques may be used to encrypt/decrypt data (e.g., authorizer identities) and/or authenticate one or more users (e.g., requestor 120, one or more authorizers, an auditor, etc.). In some embodiments, public/private key techniques may be used to verify that requests originate from module 110 (e.g., preventing requestors from attempting to bypass module 110).

In other embodiments, secure authorizer selection module 110 secures the identity of one or more authorizers cryptographically using, for example, AES Key. In some embodiments, AES key uses a matrix to store identifiers to be encrypted. In some embodiments, for 128-bit plaintext processing, AES processes the 128 bits as 16 bytes of data. For example, when creating a matrix for 16 bytes AES uses four columns and four rows to store each of the 16 bytes. In some embodiments, each element of this matrix is then processed, using substitutions and permutations, with each element of a four column by four row key matrix using XOR logic. In some embodiments, several new key matrices are derived from the original key matrix using key expansion. Each new key matrix is used to encrypt each new encrypted matrix another time, in some embodiments. In some embodiments, the number of times a matrix is encrypted is referred to as the number of rounds. In some embodiments, the number of rounds is determined by the required size of the key (e.g. 128, 192, and 256 bits corresponds to 10, 12, and 14 rounds, respectively). In some embodiments, the number of rounds is determined by module 110. In some embodiments, after a matrix is processed with a key matrix, the result is diffused by shifting and mixing the rows and columns of the matrix, respectively. In some embodiments, the final round produces an encrypted matrix that can only be encrypted with the original key maintained by module 110.

In some embodiments, the cryptographic identification and selection of one or more authorizers by module 110 prevents fraudulent behavior by one or more requestors, authorizers, auditors, etc. For example, if the identity of the selected one or more authorizers is known to the requestor, the requestor and authorizer may collude to perform fraudulent actions. Therefore, obfuscating identifying information may increase security.

### Example of a Multi-Authorizer Type of Request

FIG. 3 is a flow diagram illustrating a request requiring multiple approvers, according to some embodiments. In the illustrated embodiment, multiple approver procedure 300 includes many elements similar to those explained in FIG. 2 above and similarly numbered elements may perform the same or similar functions in FIGS. 2 and 3.

At 320, in the illustrated embodiment, system 100 determines whether a request to access a resources identified as a multi-approver type of request. At 330, in the illustrated embodiment, if all authorizers are identified and the request is approved 350, the flow ends 280. At 340, in the illustrated embodiment, if one of the multiple authorizers rejects the request, the flow ends 280 and procedure 300 will not identify another authorizer. At 332, in the illustrated embodiment, system 100 identifies the next authorizer, once the first authorizer has approved the request from the requestor 120. Although serial identification and authorizer review is shown in FIG. 3, authorizers may be identified and requested in parallel in other embodiments.

In the illustrated embodiment, similar to the embodiments explained in FIG. 2, procedure 300 includes several categories of thresholds. In the illustrated embodiment, the time threshold, attempt threshold, and final time threshold are monitored at 240, 250, and 260 while a request from the requestor 120 is being processed by procedure 300.

In some embodiments, the requestor 120 submits one or more requests to access one or more resources. In some embodiments, the requestor 120, submits one or more types of requests (e.g. a single approver request vs. a multiple approver request) processed by one or more procedures (e.g. procedures 200 and 300).

In some embodiments, when determining a set of potential authorizers, module 110 is configured to omit one or more authorizers previously selected for a request from requestor 120. In some embodiments, a first authorizer is selected from a set of potential authorizers. For a subsequent request, a second authorizer may be selected from a set of potential authorizers with the first authorizer omitted by module 110. In some embodiments, if any request from the requestor 120 (e.g. for the same resource or for a different resource) has been approved by the first authorizer, the first authorizer may be omitted for future requests from the user. In some embodiments, an authorizer may be omitted from the set of potential authorizers only if the authorizer was selected for a prior request for the same resource from the requestor 120. In some embodiments, once the number of remaining authorizers in the set reaches a threshold, module 110 may re-introduce the omitted authorizers to the set of potential authorizers for subsequent requests. In other embodiments, authorizers may be tracked and omitted from requests at various granularities of users and resources.

### Exemplary Transaction Involving an Auditor

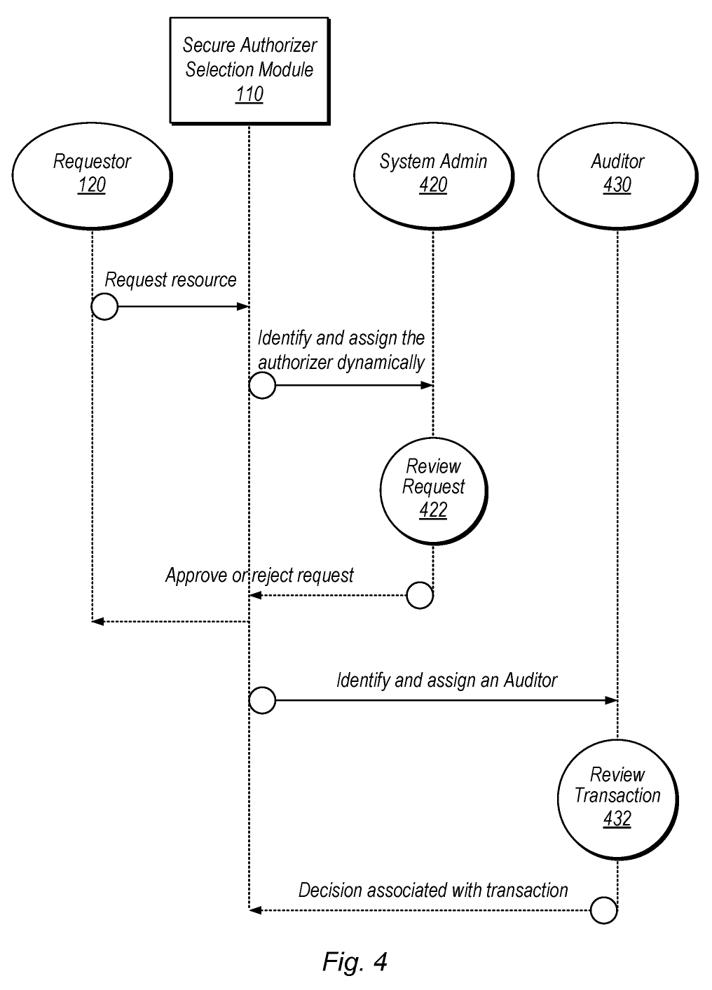

FIG. 4, is a diagram illustrating an exemplary transaction, according to some embodiments. In the illustrated embodiment, communications are performed between secure authorizer selection module 110, requestor 120, system admin 420, and auditor 430.

In the illustrated embodiment, requestor 120 submits a request for a resource. The request is sent to secure authorizer selection module 110, in the illustrated embodiment. Once module 110 receives the request, in the illustrated embodiment, it identifies and pseudo-randomly assigns an authorizer (system admin 420, in this example) dynamically.

At 422, in the illustrated embodiment, system admin 420, reviews the request and approves or rejects the request. In the illustrated example, system admin 420 approves or rejects the request before the time threshold is reached. In the illustrated embodiment, requestor 120 receives notice of the approval or rejection of the request. In the illustrated embodiment, module 110 also identifies and assigns auditor 430 to audit the request from the requestor 120. The audit may be initiated in conjunction with the approval or rejection of the request or may be initiated at a later time, e.g., based on a periodic audit procedure.

In some embodiments, module 110 pseudo-randomly selects an auditor from a set of potential auditors from the transaction, e.g., using similar techniques as described above with reference to pseudo-randomly selecting an authorizer.

At 432, in the illustrated embodiment, auditor 430 reviews the transaction after system admin 420 approves or rejects the request. In the illustrated embodiment, auditor 430 sends a decision associated with the reviewed transaction to secure authorizer selection module 110.

In some embodiments, auditor 430 may audit a request prior to its approval or rejection by system admin 420. If, in some embodiments, the auditor 430 discovers an issue with the request prior to approval or rejection of the request by system admin 420, the auditor may override the review 422 of the system admin and reject the request. In various embodiments, rejection by the auditor may prevent or detect user error (e.g. one or more authorizers grants access to a request for sensitive account information in error). In some embodiments, the transaction review 432 performed by auditor 430 has no effect on the approval or rejection of the request, but may be used to flag users, transactions, etc. for further review.

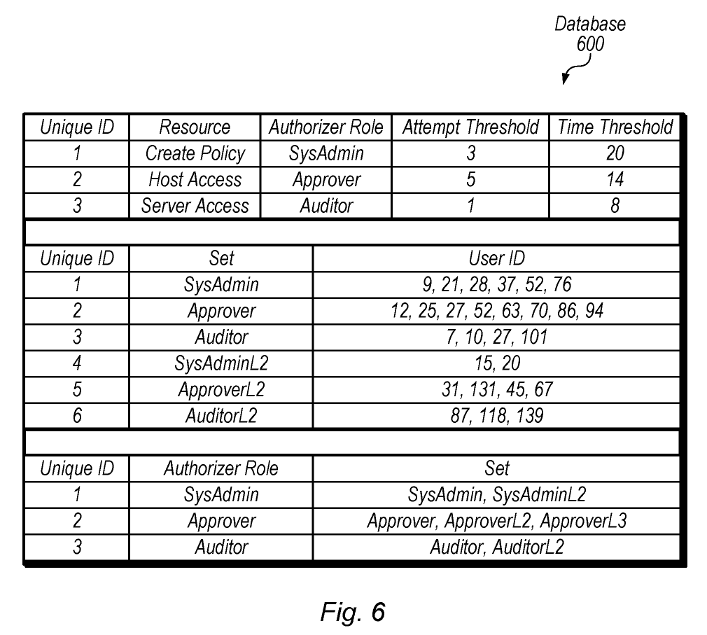

In some embodiments, audit information from the review 432 is stored internally by the secure authorizer selection module 110 to assist in identifying and selecting authorizers for future requests. In some embodiments, the audit information from review 432 is stored in a database (e.g., as shown in FIG. 6) and accessed by module 110. In various embodiments, transaction information stored in a database may include, without limitation: the number of authorizers selected for one or more transactions, the number of requests from one or more users, security restraints of one or more resources, the number of requests per resource from one or more users, activity of one or more users after access to one or more resources is authorized, etc.

Request Example with Time and Attempt Thresholds

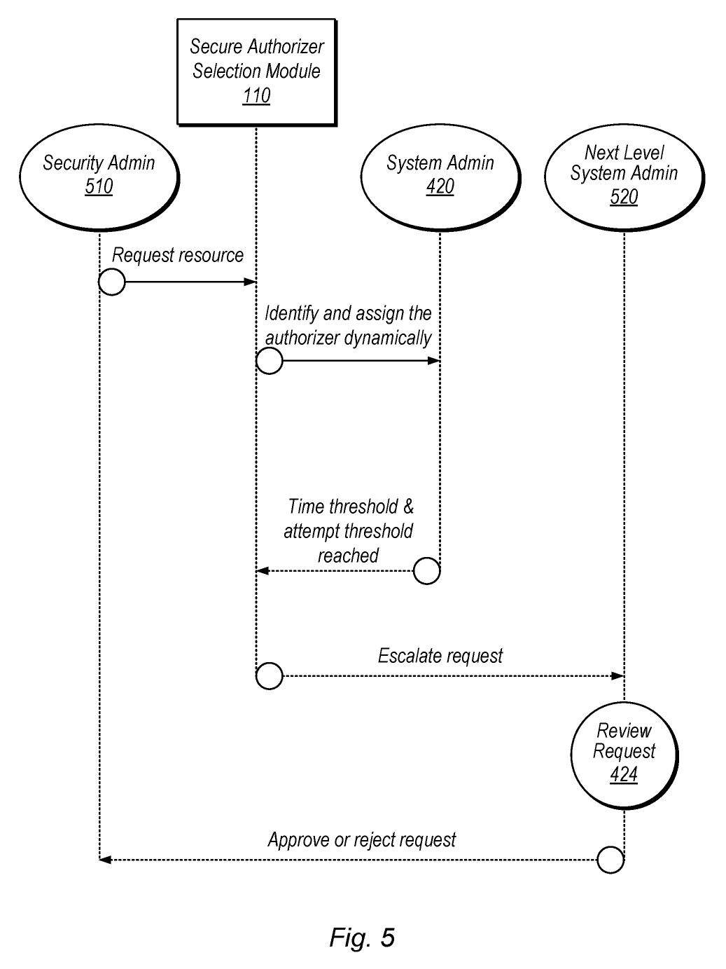

FIG. 5 is a diagram illustrating an exemplary transaction involving thresholds, according to some embodiments. In the illustrated embodiment, communications are transmitted between ones of: secure authorizer selection module 110, security admin 510, system admin 420, and next level system admin 520.

In some embodiments, security admin 510 submits a request for a resource and secure authorizer selection module 110 receives the request, identifying and pseudo-randomly assigning an authorizer dynamically for the request. This procedure may proceed similarly to that described above with reference to FIG. 4. In the illustrated example, however, system admin 420 does not review the request and both the time threshold and the attempt threshold are reached. As a result, in the illustrated embodiment, module 110 escalates the request to a newly identified and assigned authorizer, next level system admin 520 (who may be identified pseudo-randomly from a new set of authorizers or the same set of authorizers). In the illustrated embodiment, the newly identified and assigned authorizer reviews the request at 424. In the illustrated embodiment, admin 520 approves or rejects the request. Notification of the approval or rejection is sent to security admin 510, in the illustrated embodiment. In some embodiments, notification of the approval or rejection is sent indirectly via module 110. In some embodiments, notification of the approval or rejection is also sent to the system admin 420 who failed to review the request.

In some circumstances, next level system admin 520, similar to system admin 420, may not review the request at 422 such that the time and attempt thresholds are reached a second time. In some embodiments, once the time and attempt thresholds are reached a second time (or, more generally, at a particular pre-determined authorizer level), the request is canceled. In some embodiments, once the time and attempt threshold have been reached, module 110 escalates the request to one or more additional levels of authority by identifying and pseudo-randomly assigning authorizers at those additional levels. In some embodiments, once the time and attempt threshold are reached at a certain level or a certain number of times, module 110 may pseudo-randomly selects another authorizer from an old set of authorizers (e.g. a set of authorizers previously determined and selected from) to approve or reject the request.

In some embodiments, next level system admin 520 has a higher level of authority than system admin 420. In some embodiments, next level system admin 520 has the same level of authority as system admin 420. In some embodiments, system admin 420 and next level system admin 520 are selected from the same set of authorizers.

### Exemplary Database

FIG. 6 is a table illustrating an exemplary database, according to some embodiments. In the illustrated embodiment, database 600 contains three tables. In the illustrated embodiment, the first table includes the following fields: unique ID, resource, authorizer role, attempt threshold, and time threshold. In the illustrated embodiment, the second table includes the following fields: unique ID, set, and user ID. In the illustrated embodiment, the third table includes the following fields: unique ID, authorizer role, and set.

In the illustrated embodiment, the unique ID column contains an identification number associated with each category of the columns within the three tables. For example, in the illustrated embodiment, the “Create Policy” resource is assigned the unique ID “1”. In other embodiments, any of various appropriate identifier information may be used to uniquely identify database entries.

In the illustrated example, entries for three types of actions to access resources are maintained in the first table: create policy, host access, and server access. In the illustrated embodiment, an authorizer role is assigned to each type of resource. For example, in the illustrated embodiment, resource “Host Access” is assigned a generic “approver” type of role. In some embodiments, this role may be used to determine the set of authorizers from which to pseudo-randomly select.

In the illustrated embodiment, the resource types are assigned an attempt threshold as well as a time threshold. In the illustrated example, resource “Create Policy” is assigned an attempt threshold of “3” (e.g. number of attempts) and a time threshold of “20” (e.g. minutes). In this example, if an identified SysAdmin does not respond for 20 minutes three consecutive times, module 110 may select a new approver or cancel the request.

The second table, in the illustrated embodiment, may be used to maintain a list of authorizers having a given role. In the illustrated embodiment, the user ID column assigns one or more users to a given authorizer role, e.g., based on their identification number. For example, in the illustrated embodiment, the second table assigns user IDs 9, 21, 28, 37, 52, and 76 to the “SysAdmin” role. The various types of data shown in FIG. 6 are included for purposes of illustration, but it is understood that various format and representations may be used for various fields in other embodiments.

The third table, in the illustrated embodiment, specifies one or more sets of potential authorizers for each “Authorizer Role.” For example, in the illustrated embodiment, authorizer role “SysAdmin” has two sets of potential authorizers “SysAdmin” and “SysAdminL2.” In some embodiments, when determining a set of potential authorizers for a given request, module 110 may combine multiple sets of authorizers having the same role (or even different roles), for example.

In some embodiments, database 600 is accessed by the secure authorizer selection module 110 to obtain information for use in processing a transaction. In some embodiments, database 600 may have more or less information in its rows and columns than that displayed in the illustrated embodiment. For example, in some embodiments, the first table includes a column “Final Time Threshold” indicating the total amount of time (e.g. days) that can pass for each transaction. In some embodiments, the secure authorizer selection module 110 uses information from database 600 to identify and assign an authorizer to authorize a transaction. In some embodiments, the secure authorizer selection module uses database 600 to determine whether a request is a single approver request or a multiple approver request. In some embodiments, the secure authorizer selection module accesses database 600 to determine whether a request should be audited by one or more auditors.

### An Exemplary Method

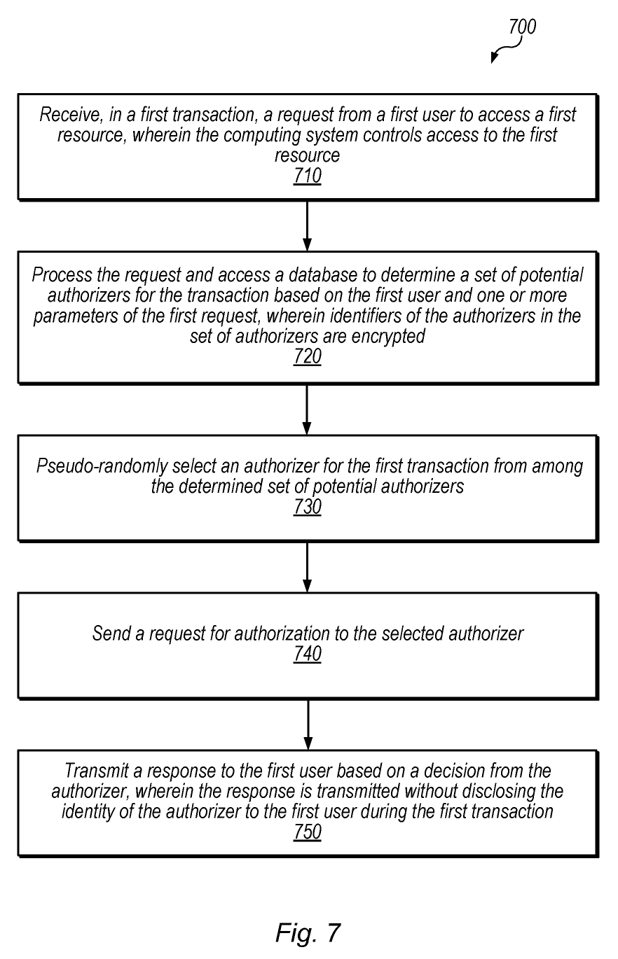

FIG. 7 is a flow diagram illustrating an exemplary method for processing a user request, according to some embodiments. The method shown in FIG. 7 may be used in conjunction with any of the computer circuitry, systems, devices, elements, or components disclosed herein, among other devices. In various embodiments, some of the method elements shown may be performed concurrently, in a different order than shown, or may be omitted. Additional method elements may also be performed as desired.

At 710, in the illustrated embodiment, a first request is received from a first user to access a first resource, where the system controls access to the first resource.

At 720, in the illustrated embodiment, the first request is processed to determine a set of authorizers for the request based on one or more parameters of the first request, where identifiers of the authorizers in the set of authorizers are encrypted. Processing the request may include decrypting (or encrypting) identifiers of one or more authorizers, authenticating one or more authorizers, obtaining additional information (e.g., from a database) regarding the requesting user, obtaining additional information regarding the requested resource, etc.

At 730, in the illustrated embodiment, an authorizer is pseudo-randomly selected for the request from among the determined set of authorizers.

At 740, in the illustrated embodiment, a request is sent to the selected authorizer for approval.

At 750, in the illustrated embodiment, a response is transmitted to the first user based on a decision from the authorizer. In the illustrated embodiment, the response is transmitted without disclosing the identity of the authorizers to the first user during the transaction. In various embodiments, the disclosed techniques may reduce collusion between requestors and authorizers.

In some embodiments, the type of request submitted by the first user to access a first resource is determined. In some embodiments, the type of request involves the approval of multiple authorizers. In some embodiments, a plurality of authorizers is pseudo-randomly selected to approve or reject the request from the first user. In some embodiments, approval of all of the selected authorizers (or a threshold number of authorizers) is required to approve the request.

In some embodiments, module 110 may receive a type of request from a requestor that should be audited by one or more auditors. In some embodiments, module 110 determines a set of potential auditors to audit the request. In some embodiments, module 110 pseudo-randomly selects one or more auditors to audit the request. In some embodiments, the identifiers of the auditors are encrypted. However, in some embodiments, the identifiers may be decrypted before a request is sent to the auditor. In some embodiments, the identifier of the auditor remains encrypted and the request is sent to the encrypted auditor. In various embodiments, some other system decrypts the auditor identifier and sends the request to the appropriate auditor.

In embodiments similar to those discussed above concerning auditors, the identifiers of the set of potential authorizers may be decrypted before an authorizer is pseudo-randomly selected by the secure authorizer selection module. In some embodiments, the identifier of the authorizer is decrypted before a request is sent to the authorizer. In other embodiments, for example, a request may be sent to some other system or module which then decrypts the identifier and routes the request to the appropriate authorizers for approval or rejection.

As used herein, the term “module” refers to circuitry configured to perform specified operations or to physical non-transitory computer readable media that stores information (e.g., program instructions) that instructs other circuitry (e.g., a processor) to perform specified operations. Modules may be implemented in multiple ways, including as a hardwired circuit or as a memory having program instructions stored therein that are executable by one or more processors to perform the operations. A hardware circuit may include, for example, custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, or the like. A module may also be any suitable form of non-transitory computer readable media storing program instructions executable to perform specified operations.

### Example Computing Device

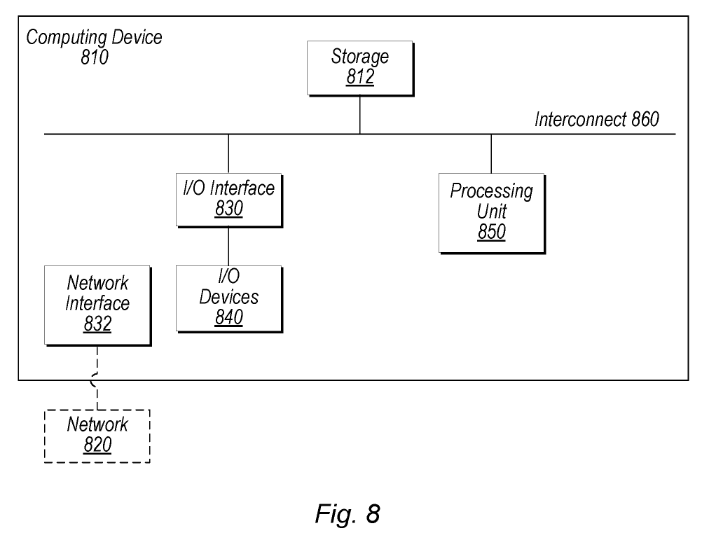

Turning now to FIG. 8, a block diagram of one embodiment of computing device (which may also be referred to as a computing system) 810 is depicted. Computing device 810 may be used to implement various portions of this disclosure. Computing device 810 may be any suitable type of device, including, but not limited to, a personal computer system, desktop computer, laptop or notebook computer, mainframe computer system, web server, workstation, or network computer. As shown, computing device 810 includes processing unit 850, storage 812, input/output (I/O) interface 830 coupled via an interconnect 860 (e.g., a system bus). I/O interface 830 may be coupled to one or more I/O devices 840. Computing device 810 further includes network interface 832, which may be coupled to network 820 for communications with, for example, other computing devices.

In various embodiments, processing unit 850 includes one or more processors. In some embodiments, processing unit 850 includes one or more coprocessor units. In some embodiments, multiple instances of processing unit 850 may be coupled to interconnect 860. Processing unit 850 (or each processor within 850) may contain a cache or other form of on-board memory. In some embodiments, processing unit 850 may be implemented as a general-purpose processing unit, and in other embodiments it may be implemented as a special purpose processing unit (e.g., an ASIC). In general, computing device 810 is not limited to any particular type of processing unit or processor subsystem.

As used herein, the terms “processing unit” or “processing element” refer to circuitry configured to perform operations or to a memory having program instructions stored therein that are executable by one or more processors to perform operations. Accordingly, a processing unit may be implemented as a hardware circuit implemented in a variety of ways. The hardware circuit may include, for example, custom very-large-scale integration (VLSI) circuits or gate arrays, off-the-shelf semiconductors such as logic chips, transistors, or other discrete components. A processing unit may also be implemented in programmable hardware devices such as field programmable gate arrays, programmable array logic, programmable logic devices, or the like. A processing unit may also be configured to execute program instructions from any suitable form of non-transitory computer-readable media to perform specified operations.

Storage subsystem 812 is usable by processing unit 850 (e.g., to store instructions executable by and data used by processing unit 850). Storage subsystem 812 may be implemented by any suitable type of physical memory media, including hard disk storage, floppy disk storage, removable disk storage, flash memory, random access memory (RAM-SRAM, EDO RAM, SDRAM, DDR SDRAM, RDRAM, etc.), ROM (PROM, EEPROM, etc.), and so on. Storage subsystem 812 may consist solely of volatile memory in one embodiment. Storage subsystem 812 may store program instructions executable by computing device 810 using processing unit 850, including program instructions executable to cause computing device 810 to implement the various techniques disclosed herein.

I/O interface 830 may represent one or more interfaces and may be any of various types of interfaces configured to couple to and communicate with other devices, according to various embodiments. In one embodiment, I/O interface 830 is a bridge chip from a front-side to one or more back-side buses. I/O interface 830 may be coupled to one or more I/O devices 840 via one or more corresponding buses or other interfaces. Examples of I/O devices include storage devices (hard disk, optical drive, removable flash drive, storage array, SAN, or an associated controller), network interface devices, user interface devices or other devices (e.g., graphics, sound, etc.).

Various articles of manufacture that store instructions (and, optionally, data) executable by a computing system to implement techniques disclosed herein are also contemplated. These articles of manufacture include non-transitory computer-readable memory media. The contemplated non-transitory computer-readable memory media include portions of a memory subsystem of a computing device as well as storage media or memory media such as magnetic media (e.g., disk) or optical media (e.g., CD, DVD, and related technologies, etc.). The non-transitory computer-readable media may be either volatile or nonvolatile memory.

What is claimed is:

1. An apparatus, comprising:
one or more processing elements configured to:
receive, in a first transaction, a first request from a first user to access a first resource, wherein the apparatus controls access to the first resource;
process the first request and access a database to determine a set of potential authorizers for the first transaction based on the first user and one or more parameters of the first request, wherein identifiers of the authorizers in the set of potential authorizers are encrypted;
pseudo-randomly select an authorizer for the first transaction from among the determined set of potential authorizers;
send a request for authorization to the selected authorizer; and
transmit a response to the first user based on a decision from the authorizer, wherein the response is transmitted without disclosing the identity of the authorizer to the first user during the first transaction.

2. The apparatus of claim 1, wherein the apparatus is configured to:
determine that the first transaction should be authorized by a plurality of authorizers, based on processing the request; and
pseudo-randomly select a plurality of authorizers for the first transaction from the set of potential authorizers.

3. The apparatus of claim 2, wherein the apparatus is further configured to:
determine that the first transaction should be reviewed by one or more auditors, based on processing the request;
determine a set of potential auditors for the request, wherein the identifiers of the auditors in the set of potential auditors are encrypted; and
pseudo-randomly select one or more auditors for the first transaction from the set of potential auditors; and
send one or more audit requests to the one or more auditors.

4. The apparatus of claim 1, wherein the apparatus is configured to:
decrypt an identifier of the selected authorizer before sending the request for authorization to the selected authorizer.

5. The apparatus of claim 1, wherein the apparatus is configured to:
store a value indicating a time threshold; and
in response to a failure of the selected authorizer to respond to the request for authorization within the indicated time threshold, resend the request from the first user to access the first resource to the selected authorizer.

6. The apparatus of claim 5, wherein the apparatus is further configured to:
store a value indicating an attempt threshold; and
in response to a failure of the selected authorizer to respond to the first request for authorization after resending the request a number of times that meets the attempt threshold, pseudo-randomly select a second authorizer and send the request from the first user to access the first resource to the second authorizer.

7. The apparatus of claim 6, wherein the second authorizer is selected from another set of potential authorizers having a higher level of authority than the set of potential authorizers.

8. The apparatus of claim 1, wherein, to determine the set of potential authorizers, the apparatus is configured to omit one or more authorizers previously selected for a request from the first user.

9. The apparatus of claim 1, further comprising:
a database configured to store information specifying:
one or more authorizers selected for one or more transactions;
a number of requests from one or more users;
security restraints of one or more requested resources;
a number of requests per resource from one or more users; and
activity of one or more users after one or more requests to access one or more resources have been authorized;
wherein the apparatus is configured to determine whether to audit the one or more transactions based on information stored in the database.

10. A method, comprising:
receiving, by a computing system for a first transaction, a first request from a first user to access a first resource, wherein the computing system controls access to the first resource;
processing the request and accessing a database, by the computing system, to determine a set of potential authorizers for the first transaction based on the first user and one or more parameters of the first request, wherein identifiers of the authorizers in the set of potential authorizers are encrypted;
pseudo-randomly selecting, by the computing system, an authorizer for the first transaction from among the determined set of potential authorizers;
sending, by the computing system, a request for authorization to the selected authorizer; and
transmitting, by a computing system, a response to the first user based on a decision from the authorizer, wherein the response is transmitted without disclosing the identity of the authorizer to the first user during the first transaction.

11. The method of claim 10, further comprising:
determining that a type of the first request, indicated by the one or more parameters, should be authorized by a plurality of authorizers; and
pseudo-randomly selecting a plurality of authorizers for the request from the set of potential authorizers.

12. The method of claim 10, further comprising:
determining that a type of the first request, indicated by the one or more parameters, should be audited by one or more auditors;
determining a set of potential auditors, wherein the identifiers of the auditors in the set of potential auditors are encrypted; and
pseudo-randomly selecting the one or more auditors to audit the first transaction.

13. The method of claim 10, wherein pseudo-randomly selecting the authorizer for the request from among the determined set of potential authorizers includes decrypting an identifier of the selected authorizer before sending a request for authorization to the selected authorizer.

14. The method of claim 10, further comprising:
storing a value indicating a time threshold; and
sending a second request for authorization to the selected authorizer, in response to a failure of the selected authorizer to respond to the request from the first user to access the first resource within the indicated time threshold.

15. The method of claim 14, further comprising:
storing a value indicating an attempt threshold;
pseudo-randomly selecting a second authorizer and sending the request from the first user to access the first resource to the second authorizer, in response to a failure of the selected authorizer to respond to the request from the first user to access the first resource after resending the request a number of times that meets the indicated attempt threshold.

16. The method of claim 15, wherein the second authorizer is selected from another set of potential authorizers having a higher level of authority than the set of potential authorizers.

17. A non-transitory computer readable medium having instructions stored thereon that are executable by a computer system to perform operations comprising:
receiving, in a first transaction, a first request from a first user to access a first resource, wherein the computing system controls access to the first resource;
processing the request and accessing a database to determine a set of potential authorizers for the first transaction based on the first user and one or more parameters of the first request, wherein identifiers of the authorizers in the set of potential authorizers are encrypted;
pseudo-randomly selecting an authorizer for the first transaction from among the determined set of potential authorizers;
sending, a request for authorization to the selected authorizer; and
transmitting, a response to the first user based on a decision from the authorizer, wherein the response is transmitted without disclosing the identity of the authorizer to the first user during the first transaction.

18. The non-transitory computer readable medium of claim 17, wherein the operations further comprise:
determining that a type of the first request, indicated by the one or more parameters, should be authorized by a plurality of authorizers; and
pseudo-randomly selecting a plurality of authorizers for the request from the set of potential authorizers.

19. The non-transitory computer readable medium of claim 17, wherein the operations further comprise:
determining that a type of the first request, indicated by the one or more parameters, should be audited by one or more auditors;
determining a set of potential auditors, wherein the identifiers of the auditors in the set of potential auditors are encrypted; and
pseudo-randomly selecting the one or more auditors to audit the first transaction.

20. The non-transitory computer readable medium of claim 17, wherein the operations further comprise:
store information in a database that specifies:
one or more authorizers selected for one or more transactions;
a number of requests from one or more users;
security restraints of one or more requested resources;
a number of requests per resource from one or more users; and
activity of one or more users after one or more requests to access one or more resources have been authorized;
wherein the computer system is configured to determine whether to audit one or more transactions based on information stored in the database.
